(19) United States
(12) Patent Application Publication
(10) Pub. No.: US 2026/0164280 A1
(43) Pub. Date: Jun. 11, 2026

(54) MOBILITY ENHANCEMENT: LTM

(71) Applicant: MEDIATEK INC., Hsinchu City (TW)

(72) Inventors: Din-Hwa HUANG, Hsinchu City (TW); Cheng-Rung TSAI, Hsinchu City (TW)

(21) Appl. No.: 19/123,902

(22) PCT Filed: Nov. 3, 2023
(86) PCT No.: PCT/CN2023/129783

§ 371 Date: Apr. 24, 2025

Related U.S. Application Data
(60) Provisional application No. 63/382,303, filed on Nov. 4, 2022.

(51) Int. Cl. H04W 24/10; H04W 72/231; H04W 72/51

(52) U.S. Cl. CPC H04W 24/10; H04W 72/231; H04W 72/51

(57) ABSTRACT

A UE reports, to a network, a first capability of performing measurements using asynchronous TCI states, indicating that a RTD between a beam of a serving cell and a beam of a NBR cell is larger than a length of one CP. The UE receives a configuration of a candidate set of beams for performing L1 measurements. The UE performs L3 measurements on corresponding SSBs and L1 measurements on the candidate set of beams on a set of measurement occasions that are shared between the L1 measurements and the L3 measurements, wherein the set of measurement occasions include a respective measurement occasion for each of the corresponding SSBs of the L3 measurements, wherein L1 and L3 measurement periods are greater than corresponding periods not containing a L1 measurement of asynchronous beams of a NBR cell. The UE reports the L3 and L1 measurements to the network.

### CROSS-REFERENCE TO RELATED APPLICATION(S)

This application claims the benefits of U.S. Provisional Application Ser. No. 63/382,303, entitled “3 GPP REL-18 MOBILITY ENHANCEMENTS” and filed on Nov. 4, 2022, which is expressly incorporated by reference herein in its entirety.

### BACKGROUND

### Field

The present disclosure relates generally to communication systems, and more particularly, to techniques of mobility enhancement.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE reports, to a network, a first capability of performing measurements using asynchronous transmission configuration indicator (TCI) states, indicating that a receiving timing difference (RTD) between a beam of a serving cell and a beam of a neighboring (NBR) cell is larger than a length of one cyclic prefix (CP). The UE receives a configuration of a candidate set of beams of the serving cell and at least one neighboring cell of the UE for performing L1 measurements. The UE performs L3 measurements on corresponding SSBs of the serving cell and one or more NBR cells and L1 measurements on the candidate set of beams on a set of measurement occasions that are shared between the L1 measurements and the L3 measurements. The set of measurement occasions include a respective measurement occasion for each of the corresponding SSBs of the L3 measurements. L1 and L3 measurement periods are greater than corresponding periods not containing a L1 measurement of asynchronous beams of a neighboring (NBR) cell. The UE reports the L3 and L1 measurements to the network.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a handover process.

FIG. 8 is a diagram illustrating synchronous and asynchronous TCI states.

FIG. 9 is a diagram illustrating shared L1 and L3 measurement resources.

FIG. 10 is a flow chart of a method (process) for handover.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

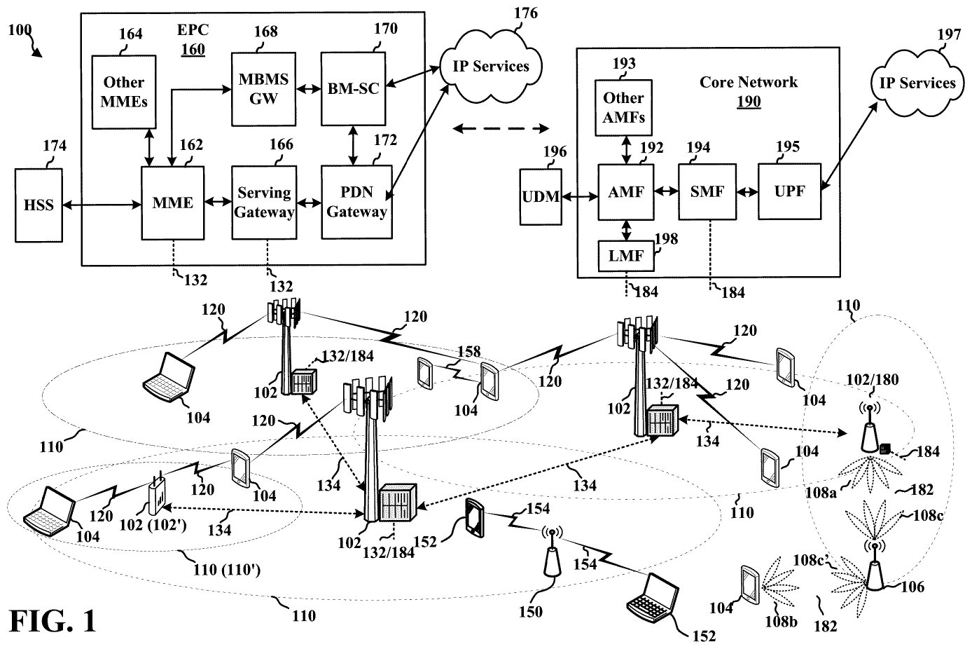

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to X MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

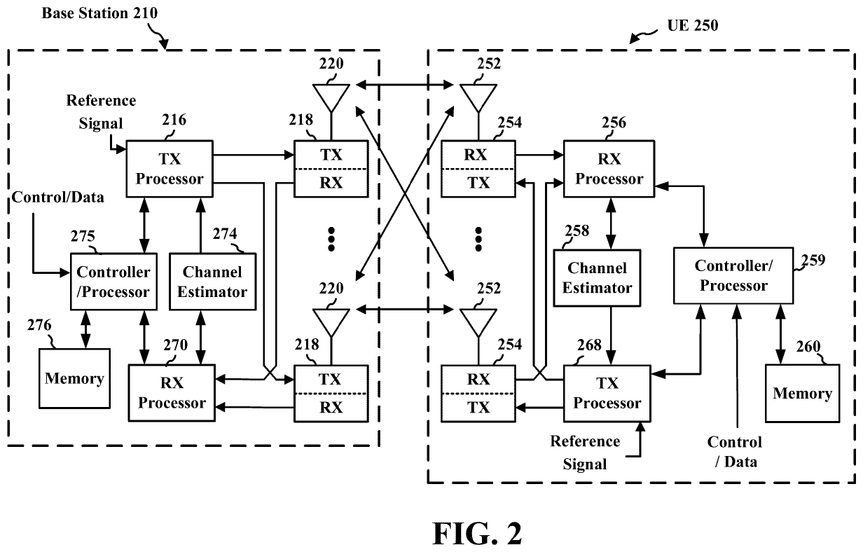

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

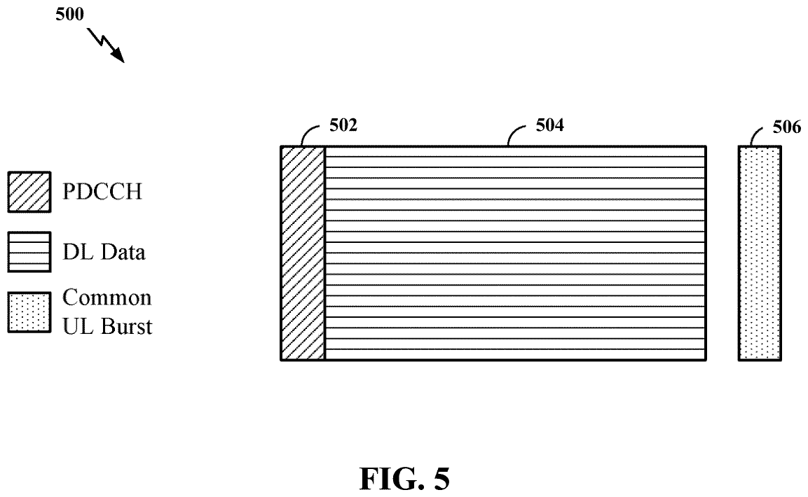

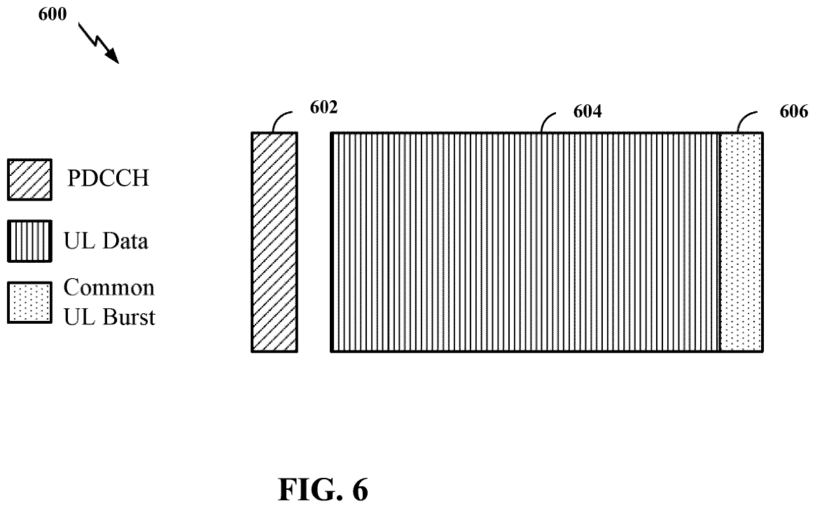

A single component carrier bandwidth of 100 MHz may be supported. In one example, NR resource blocks (RBs) may span 12 sub-carriers for each RB with a sub-carrier spacing (SCS) of 60 kHz over a 0.25 ms duration or a SCS of 30 kHz over a 0.5 ms duration (similarly, 15kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

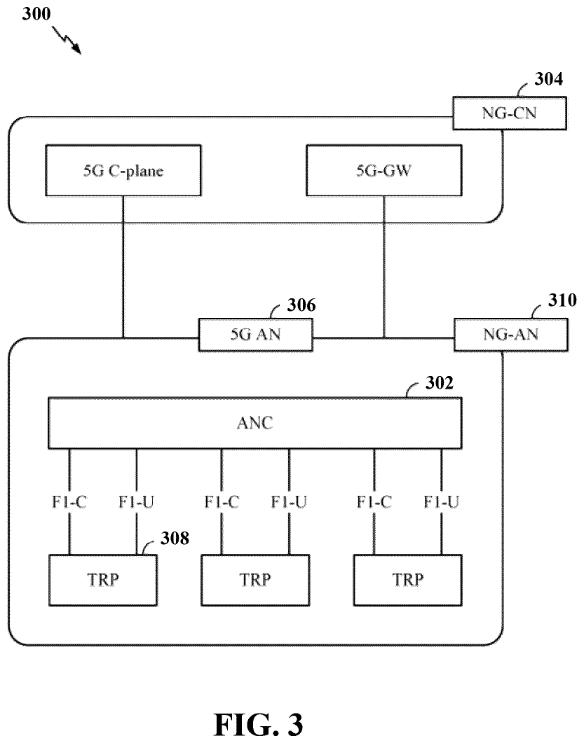

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

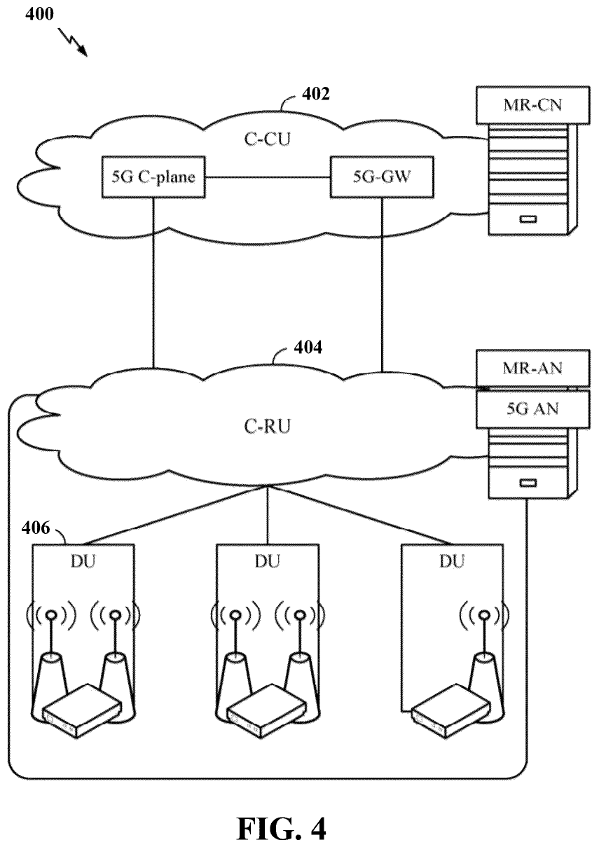

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

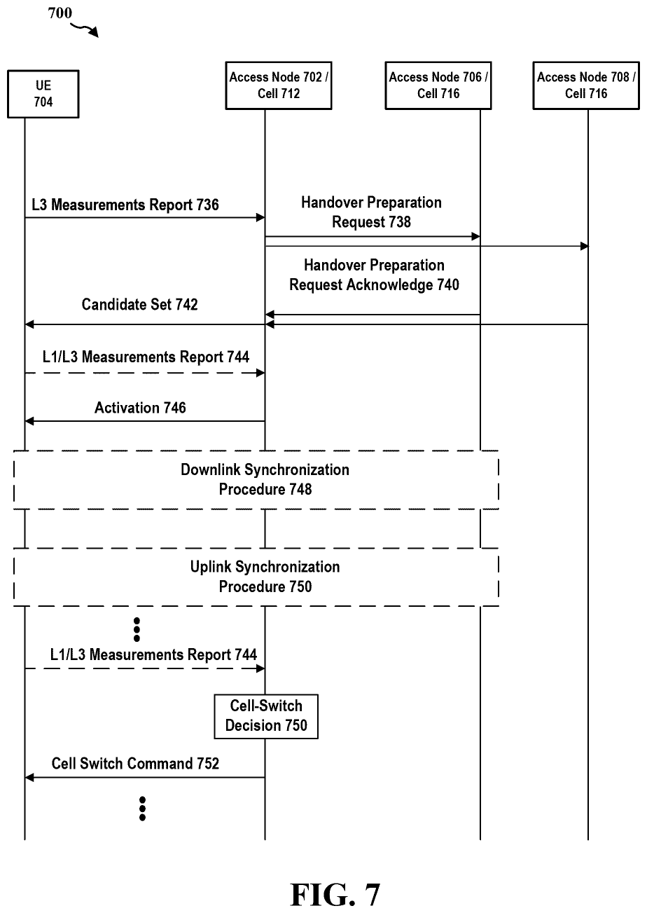

FIG. 7 is a diagram 700 illustrating a handover process. In this example, a UE 704 is connected to an access node 702 through a cell 712, which now is the serving cell of the UE 704. Further, a cell 716 provided by an access node 706 and a cell 718 provided by an access node 708 are neighboring cells of the UE 704. The UE 704 is in the coverage of the cell 716 and the coverage of the cell 718.

Each of the access nodes 702, 706, 708 may be a radio unit (RU), a transmission reception point (TRP), or a base station (cell). The access nodes 702, 706, 708 are in communication with and are under the control of one or more control entities. The control entities may include a distributed unit (DU), a centralized unit (CU), a base station, and/or a network implementing various functions. In certain configurations RUs are radio hardware that transmits and receives radio signals to/from the UE. It handles functions like modulation/demodulation, amplifying, encoding/decoding etc. A DU controls the RUs connected to it. It handles certain lower layer functions like scheduling, radio resource control, encoding/decoding packets etc. A CU is the main unit that controls multiple DUs. It handles higher layer functions like radio resource management, mobility management, QoS management etc.

The UE 704 periodically sends a L3 measurement report 736 to the network through the access node 702. As the serving cell signal gets weaker and a neighbor cell gets stronger, this will be reflected in the L3 reports. The network uses these reports to decide when to trigger a handover to a better target cell. Subsequently, the network may determine that the cell 716 provided by the access node 706 as well as the cell 718 provided by the access node 708 are candidate cells for handing over the UE 704. Accordingly, the access node 702 may send to the access node 706 and the access node 708 each a handover preparation request message 738 to ask the access node 706 and the access node 708 to prepare the handover process. If the access node 706 and the access node 708 admit the UE 704, then they each reply a handover preparation request acknowledge 740.

The access node 702 sends the UE 704 a candidate set of beams 742 for the UE 704 to perform L1 measurements. The candidate set of beams may include one or more beams of the cell 716 and one or more beams of the cell 718.

Accordingly, the UE 704 periodically perform L3 measurements based on all beams of the cell 712 and L1 measurements of the beams in the candidate set of beams 742. The UE 704 generates and sends L1/L3 Measurements Report 744 to the access node 702.

Subsequently, the access node 702 sends to the UE 704 an activation 746, which instructs the UE 704 to perform a downlink synchronization procedure 748 and a uplink synchronization procedure 750 with both the cell 716 and the cell 718.

The UE 704 continues performing L1 and L3 measurements and reporting them to the access node 702, until the network makes a cell switch decision, in which a target cell (e.g., the cell 716 or the cell 718) for the handover is determined.

The access node 702 then issues a cell switch command 752 to the UE 704, instructing the UE 704 switch to the target cell. The UE 704 then continue to finish the handover process to the target cell.

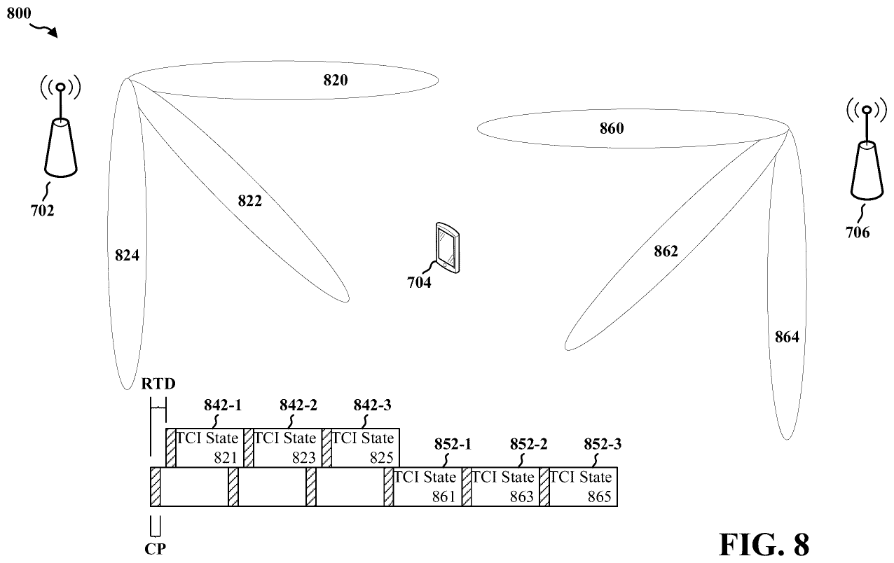

FIG. 8 is a diagram 800 illustrating synchronous and asynchronous TCI states. As described supra, when generating the L1/L3 Measurements Report 744, the UE 704 performs L1 measurements of candidate set of beams 742 from all of the cell 712, the cell 716, and the cell 718. In this example, the access node 702 forms beams 820, 822 and 824 on the cell 712. The access node 706 forms beams 860, 862 and 864 on the cell 716.

In this example, the candidate set of beams 742 includes the beams 820, 822, 824 on the cell 712 and the beams 860, 862, 864 on the cell 716. The signals on the beams 820, 822, 824 are transmitted by the access node 702 in the symbols 842-1, 842-2, 842-3, respectively. The signals on the beams 860, 862, 864 are transmitted by the access node 706 in the symbols 852-1, 852-2, 852-3, respectively.

The UE 704 uses 3 different TCI states to receive the signals on the beams 820, 822, 824. The TCI state 821 is corresponding the beam 820, the TCI state 823 is corresponding the beam 822, and the TCI state 825 is corresponding the beam 824. The UE 704 uses another 3 different TCI states to receive the signals on the beams 860, 862, 864. The TCI state 861 is corresponding the beam 860, the TCI state 863 is corresponding the beam 862, and the TCI state 865 is corresponding the beam 864.

The TCI states 821, 823 and 825 are synchronous because they are transmitted by same access node 702. The TCI states 861, 863 and 865 are synchronous because they are transmitted by same access node 706.

The receiving timing difference (RTD) is the timing difference between the symbol boundaries of the symbols 842-1, 842-2, 842-3 and the symbol boundaries of the symbols 852-1, 852-2, 852-3. If the relative timing difference (RTD) is not larger than the length of one cyclic prefix (CP), the TSI state set from the access node 702 and the TSI state set from the access node 706 may be considered as synchronous. If the RTD is large than the length of one CP, the TSI states 821, 823 and 825 and the TSI states 861, 863 and 865 are asynchronous.

In this example, the RTD is greater than one CP. When the receiving timing difference (RTD) between the serving cell and the neighboring cell is larger than one CP, it can cause issues for some UEs in performing L1 measurements on the neighboring cell. The increased asynchronicity creates challenges in signal processing and cell switching.

One issue is that the UE may not be able to process signals from both cells within one FFT window. With a small RTD (less than 1 CP), the UE can buffer and process signals from both cells together in the same FFT window. However, with a larger RTD exceeding 1 CP, the signals are too far apart in time to fit within the same FFT window. This would require the UE to use separate FFT windows for each cell, increasing the signal processing requirements.

Another issue is that switching between beams may require retuning of the RF frontend or adjusting timing alignment. If the RTD is small, there is enough overlap between the symbol boundaries of the beams to switch without data loss. However, with a larger RTD over 1 CP, there may not be enough overlap between beams, causing data loss during the switching period as symbols become misaligned.

In this example, the UE 704 supports L1 measurement on asynchronous TCI states, where the receiving timing difference (RTD) between the serving cell and the neighboring cell is larger than 1 cyclic prefix (CP). The UE 704 further reports its capability to the access node 702. The network learns that the UE 704 supports this capability, and can accordingly extended the L3 measurement period and L1 RSRP reporting time to accommodate L1 measurements of neighboring cells.

Additionally, a scheduling restriction should be applied to the serving cell (e.g., the cell 712) to add 1 data symbol before and after the neighboring cell's (e.g., the cell 716's) tracking reference signals (TRS). This helps avoid interference when the UE 704 switches between receiving signals from the serving cell beam 822 and the neighboring cell beam 862, which have symbol boundaries indicated by 842-1, 842-2, 842-3 and 852-1, 852-2, 852-3 respectively. The larger RTD causes misalignment between the symbol boundaries, so extra symbols are needed to switch between receiving from the two cells.

Further, The UE reports several capabilities to assist the network in configuring measurements and mobility procedures. N is the max number of synchronous TCI states (aligned with serving cell) that can be activated for measurement. This determines how many serving cell beams can be measured. M is The max number of asynchronous TCI states (misaligned with serving cell) that can be activated for measurement of neighboring cells. L₁ is the total number of cells that can have active TCI states for measurement. L₂ is The number of cells that can be triggered for RACH simultaneously. L₂≤L₁. Reporting these capabilities allows the network to properly configure the measurements and mobility procedures within the UE's limits.

Based on the UE's reported capabilities, the network configures the measurements and mobility procedures. First, the network activates K₁ TCI states using a MAC CE, which are associated with C₁ cells. Here C₁ must be less than or equal to L₁, which is the max number of cells with active TCI states the UE supports. This allows the network to activate measurements on beams from serving and neighboring cells.

Next, the network triggers the UE to perform RACH procedure or PRACH transmissions on C₂ cells, or on K₂ activated TCI states associated with C₂ cells. The number C₂ must be less than or equal to L₂, which is the max number of cells the UE can be triggered for RACH simultaneously. The RACH procedure can be triggered using the TCI activation command, or through a PDCCH order.

The network also indicates whether the UE should receive a msg2 after the PRACH transmissions on the triggered cells. This allows coordination of the random access process.

Once the network has configured the measurements and mobility procedures, the UE may start to pre-perform time-frequency tracking on the K₁ TCI states that were activated by the network. This allows it to maintain synchronization on the serving cell and neighboring cell beams prior to handover.

The UE also transmits PRACH preambles on the K₂ activated TCI states that were triggered by the network. The values of K₁ and K₂ depend on the UE's capabilities and the network's configuration.

After transmitting the PRACH preambles, if the network did not indicate whether the UE should receive a msg2, then the UE receives the corresponding msg2 on the serving cell following the triggered PRACH transmissions. Since the UE is not yet configured for the target cell, it receives msg2 from its current serving cell.

By pre-synchronizing to the target cell beams and transmitting PRACH, the UE is prepared for a fast and seamless handover when the cell switch command is finally issued. And coordination through msg2 allows the random access process to be completed properly.

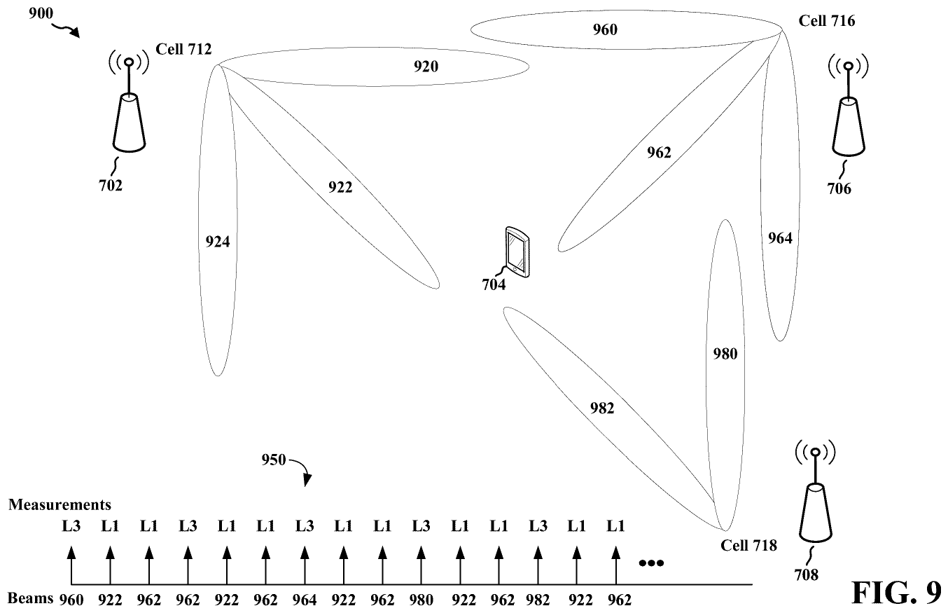

FIG. 9 is a diagram 900 illustrating shared L1 and L3 measurement resources. In this example, the access node 702 activates, for the UE 704, 8 TCI states which are corresponding beams 920, 922 and 924 of the cell 712, beams 960, 962 and 964 of the cell 716, and beams 980 and 982 of the cell 718. Therefore, K₁=8 and C₁=3. The UE 704 needs to submit L3 measurement reports of the 8 beams periodically. In particular, the UE measures synchronization signal blocks (SSBs) of the cells 712, 716, 718 in the directions of those 8 beams.

As described supra referring FIG. 7, the network may indicate the candidate set of beams 742 to the UE 704. The candidate set of beams 742 may include the beam 922 and the beam 962 for L1 measurements.

To support L1 measurement on asynchronous TCI states, the L3 measurement period and L1 RSRP reporting time need to be extended. The L3 measurement period T_{meas,layer 3} can be extended by a factor of P₁.

In this example, there are 2 additional L1 measurements (the beam 922 and 962). Both L1 measurements have the same higher priority and are performed every third beam measurement occasions. The L3 measurements need 8 measurement occasions to measure all 8 beams. As such, there is only one measurement occasion in every 3 measurement occasions for L3 measurements. Therefore, P₁ is 3 in this example.

The beam management requirement time is calculated as:

$$max ( {T}_{Report} , ceil ( 1.5 * M * {P}_{1} * N ) * max ( {T}_{DRX} , {T}_{{SSB}_{CBP}} ) )$$

T_{Report} is the periodic L1/L3 measurement reporting time configured by the network. This represents the regular reporting cadence without any extension. The second term inside the max( ) function calculates an extended measurement time needed to sweep through all beams. More specifically, 1.5 is a margin factor. M is the number of cells to measure. P₁ is the sharing factor between L1 and L3 measurements. N is the number of beams to measure. T∇DRX is the DRX cycle length, and T_{SSB}_{_{CDP}} is the SSB measurement timing configuration periodicity. Taking the max( ) of T_{DRX} and T_{SSB}_{_{CDP}} ensures the actual measurement time accounts for both the DRX cycle and SSB periodicity. Finally, taking the max( ) of the regular reporting time T_{Report} and the extended measurement time gives the overall beam management requirement time. This allows it to accommodate both regular and extended measurements.

FIG. 9 further shows an exemplary measurements pattern of the UE 704. As shown, the UE 704 performs the L3 measurements on the beam 960, the L1 measurements on the beam 922, the L1 measurements on the beam 962, and then back the L3 measurements on the beam 962, and so on

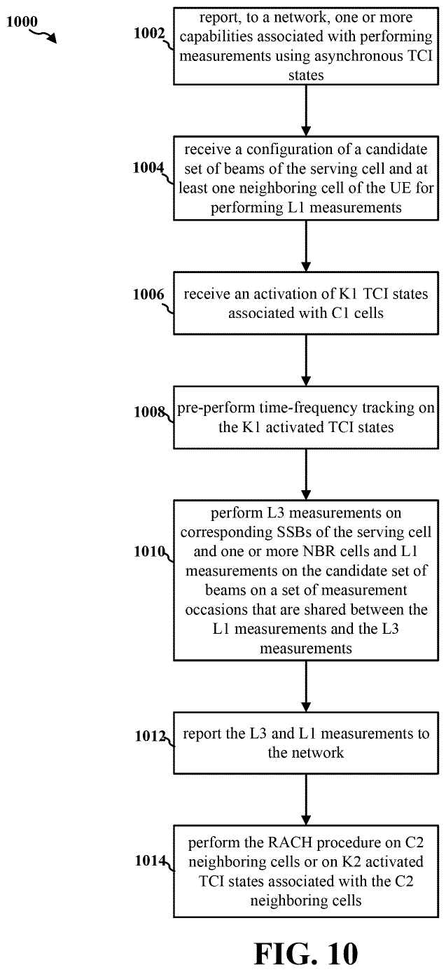

FIG. 10 is a flow chart 1000 of a method (process) for handover. The method may be performed by a UE. In operation 1002, the UE reports, to a network, a first capability of performing measurements using asynchronous transmission configuration indicator (TCI) states, indicating that a receiving timing difference (RTD) between a beam of a serving cell and a beam of a neighboring (NBR) cell is larger than a length of one cyclic prefix (CP). The UE may also report a second capability of a maximum number of synchronous activated TCI states associated with the serving cell. The UE may further report a third capability of a maximum number of asynchronous activated TCI states associated with the at least one neighboring cell. The UE may report a fourth capability of a maximum total number of synchronous activated TCI states associated with the serving cell and asynchronous activated TCI states associated with the at least one neighboring cell. Further, the UE reports a fifth capability of a maximum number of cells associated with activated TCI states. The UE reports a sixth capability of a maximum number of cells that can be simultaneously triggered for random access channel (RACH) procedure by a command.

In operation 1004, the UE receives a configuration of a candidate set of beams of the serving cell and at least one neighboring cell of the UE for performing L1 measurements. In operation 1006, the UE receives, via a medium access control (MAC) control element (CE), an activation of K1 TCI states associated with C1 cells. K1 is less than the total number of fourth capability and C1 is less than the fifth capability. In operation 1008, the UE pre-performs time-frequency tracking on the K1 activated TCI states.

In operation 1010, the UE performs L3 measurements on corresponding SSBs of the serving cell and one or more NBR cells and L1 measurements on the candidate set of beams on a set of measurement occasions that are shared between the L1 measurements and the L3 measurements. The set of measurement occasions include a respective measurement occasion for each of the corresponding SSBs of the L3 measurements. L1 and L3 measurement periods are greater than corresponding periods not containing a L1 measurement of asynchronous beams of a NBR cell. In operation 1012, the UE reports the L3 and L1 measurements to the network.

In operation 1014, upon receiving a trigger, the UE performs the RACH procedure on C2 neighboring cells or on K2 activated TCI states associated with the C2 neighboring cells. C2 is less than the sixth capability. In certain configurations, the RACH procedure performed on a neighboring cell is trigged by a PDCCH order, or the RACH procedure performed on an activated TCI state associated with the neighboring cell is trigged by a same command for TCI state activation. In certain configurations, the UE receives, from the network, an indication whether to receive a message 2 after triggered RACH transmissions. If the indication is not received, the UE receives the message 2 on the serving cell following the triggered RACH transmissions.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a user equipment (UE), comprising:
reporting, to a network, a first capability of performing measurements using asynchronous transmission configuration indicator (TCI) states, indicating that a receiving timing difference (RTD) between a beam of a serving cell and a beam of a neighboring (NBR) cell is larger than a length of one cyclic prefix (CP);
receiving a configuration of a candidate set of beams of the serving cell and at least one neighboring cell of the UE for performing L1 measurements;
performing L3 measurements on corresponding SSBs of the serving cell and one or more NBR cells and L1 measurements on the candidate set of beams on a set of measurement occasions that are shared between the L1 measurements and the L3 measurements, wherein the set of measurement occasions include a respective measurement occasion for each of the corresponding SSBs of the L3 measurements, wherein L1 and L3 measurement periods are greater than corresponding periods not containing a L1 measurement of asynchronous beams of a neighboring (NBR) cell ; and
reporting the L3 and L1 measurements to the network.

2. The method of claim 1, further comprising:
reporting a second capability of a maximum number of synchronous activated TCI states associated with the serving cell.

3. The method of claim 2, further comprising:
reporting a third capability of a maximum number of asynchronous activated TCI states associated with the at least one neighboring cell.

4. The method of claim 3, further comprising:
reporting a fourth capability of a maximum total number of synchronous activated TCI states associated with the serving cell and asynchronous activated TCI states associated with the at least one neighboring cell.

5. The method of claim 4, further comprising:
reporting a fifth capability of a maximum number of cells associated with activated TCI states.

6. The method of claim 5, further comprising:
reporting a sixth capability of a maximum number of cells that can be simultaneously triggered for random access channel (RACH) procedure by a command.

7. The method of claim 6, further comprising:
receiving, via a medium access control (MAC) control element (CE), an activation of K1 TCI states associated with C1 cells.

8. The method of claim 7, wherein K1 is less than the total number of fourth capability and C1 is less than the fifth capability.

9. The method of claim 6, further comprising:
receiving a trigger to perform the RACH procedure on C2 neighboring cells or on K2 activated TCI states associated with the C2 neighboring cells.

10. The method of claim 9, wherein C2 is less than the sixth capability.

11. The method of claim 9, wherein the RACH procedure performed on a neighboring cell is trigged by a PDCCH order, or the RACH procedure performed on an activated TCI state associated with the neighboring cell is trigged by a same command for TCI state activation.

12. The method of claim 9, further comprising:
receiving, from the network, an indication whether to receive a message 2 after triggered RACH transmissions.

13. The method of claim 12, further comprising:
receiving the message 2 on the serving cell following the triggered RACH transmissions when the indication is not received.

14. The method of claim 7, further comprising:
pre-performing time-frequency tracking on the K1 activated TCI states before a cell switch command.

15. An apparatus for wireless communication, the apparatus being a user equipment (UE), comprising:
a memory; and
at least one processor coupled to the memory and configured to:
report, to a network, a first capability of performing measurements using asynchronous transmission configuration indicator (TCI) states, indicating that a receiving timing difference (RTD) between a beam of a serving cell and a beam of a neighboring (NBR) cell is larger than a length of one cyclic prefix (CP);
receive a configuration of a candidate set of beams of the serving cell and at least one neighboring cell of the UE for performing L1 measurements;
perform L3 measurements on corresponding SSBs of the serving cell and one or more NBR cells and L1 measurements on the candidate set of beams on a set of measurement occasions that are shared between the L1 measurements and the L3 measurements, wherein the set of measurement occasions include a respective measurement occasion for each of the corresponding SSBs of the L3 measurements, wherein L1 and L3 measurement periods are greater than corresponding periods not containing a L1 measurement of asynchronous beams of a neighboring (NBR) cell; and
report the L3 and L1 measurements to the network.

16. The apparatus of claim 15, wherein the at least one processor is further configured to:
report a second capability of a maximum number of synchronous activated TCI states associated with the serving cell.

17. The apparatus of claim 16, wherein the at least one processor is further configured to:
report a third capability of a maximum number of asynchronous activated TCI states associated with the at least one neighboring cell.

18. The apparatus of claim 17, wherein the at least one processor is further configured to:
report a fourth capability of a maximum total number of synchronous activated TCI states associated with the serving cell and asynchronous activated TCI states associated with the at least one neighboring cell.

19. The apparatus of claim 18, wherein the at least one processor is further configured to:
report a fifth capability of a maximum number of cells associated with activated TCI states.

20. A computer-readable medium storing computer executable code for wireless communication of a user equipment (UE), comprising code to:
report, to a network, a first capability of performing measurements using asynchronous transmission configuration indicator (TCI) states, indicating that a receiving timing difference (RTD) between a beam of a serving cell and a beam of a neighboring (NBR) cell is larger than a length of one cyclic prefix (CP);
receive a configuration of a candidate set of beams of the serving cell and at least one neighboring cell of the UE for performing L1 measurements;
perform L3 measurements on corresponding SSBs of the serving cell and one or more NBR cells and L1 measurements on the candidate set of beams on a set of measurement occasions that are shared between the L1 measurements and the L3 measurements, wherein the set of measurement occasions include a respective measurement occasion for each of the corresponding SSBs of the L3 measurements, wherein L1 and L3 measurement periods are greater than corresponding periods not containing a L1 measurement of asynchronous beams of a neighboring (NBR) cell; and
report the L3 and L1 measurements to the network.
